(19) United States
(12) Patent Application Publication
(10) Pub. No.: US 2018/0069460 A1
(43) Pub. Date: Mar. 8, 2018

(54) Electromagnet automobile engine

(71) Applicant: John Kissane, Far Hills, NJ (US)

(72) Inventor: John Kissane, Far Hills, NJ (US)

(21) Appl. No.: 15/330,335

(22) Filed: Sep. 8, 2016

(51) Int. Cl. H02K 16/00; H02K 3/18; H02K 1/08

(52) U.S. Cl. CPC H02K 16/00; H02K 1/08; H02K 3/18

(57) ABSTRACT

My invention shows how to get increased torque and efficiency in an electric car. By combining the use of an electric motor and an electromagnet focused on a cog of north and south poled magnets the increased strength of the electromagnet could be used to provide greater torque to an electric car. Furthermore the arrangement of motor and electromagnet could be used to provide greater efficiency of the engine. By using only a small amount of battery power to slightly turn the motor the bulk of the force used to propel the car could come from the electromagnet. The loads on the respective batteries could be maximized.

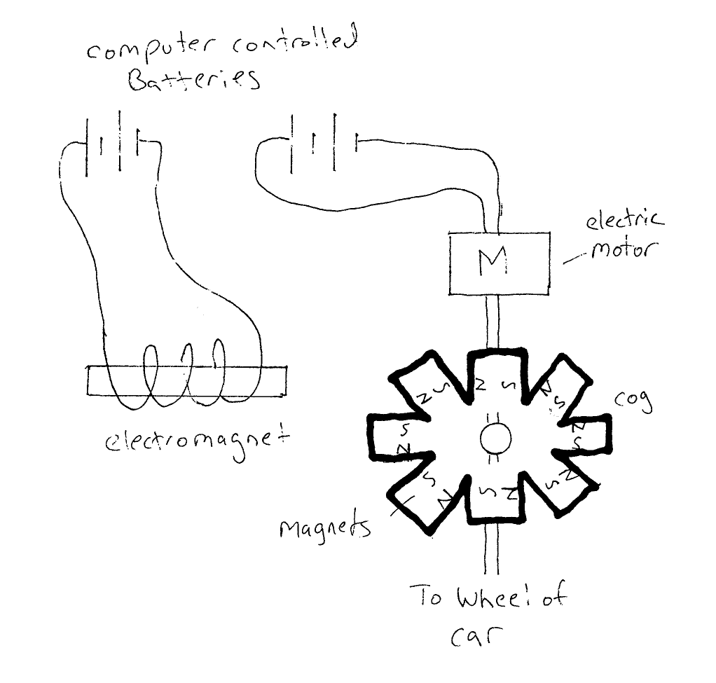

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

For years people have been trying to invent an electric car that would have the same capabilities as an internal combustion engine car. The problems they have had are that the motors are not strong enough and the batteries do not last long enough.

### BRIEF SUMMARY OF THE INVENTION

My invention shows how to use a combination of an electric motor and an electromagnet to propel a car.

### BRIEF DESCRIPTION OF THE DRAWING

The drawing shows a rotating cog made up of north and south Polar magnets. This cog is connected to an electric motor by one shaft, and is also connected to the wheel of a car by an other shaft. The electric motor is connected to a battery. Furthermore the cog is acted upon by an electromagnet which is also connected to a separate battery.

### DETAILED DESCRIPTION OF THE INVENTION

Referring more particularly to the drawing, The cog composed of alternating north and south pole magnets is capable of rotation. When the electric motor is engaged by the battery, it begins to rotate the cog through the shaft that connects the cog and the motor. Furthermore the wheel of the car begins to rotate by the shaft that is also connected to the other side of the cog. However, my invention differs by having an electromagnet also act upon the cog. This electromagnet is powered by a separate battery. In my invention the motor provides the turning of the cog and the wheel, and the electromagnet provides the torque.

Because an electromagnet can be charged much stronger then a permanent magnet in a motor it can provide a greater torque for the electric car. An electric car with only an electric motor cannot provide as much torque.

What I claim as my invention is:

1. A unique combination of an electric motor and an electromagnet combined to provide the propulsion for an electric car, because an electromagnet can be made much stronger then a permanent magnet the electric car using my invention would be provided with increased torque, also it would have increased efficiency, The motor would provide only basic turning of a cog that is connected to the wheel and it would be acted upon by a very strong electromagnet which would provide much of the torque.
